(19) United States
(12) Patent Application Publication
(10) Pub. No.: US 2010/0228002 A1
(43) Pub. Date: Sep. 9, 2010

(54) SELF-CROSSLINKING POLYAMIC ACID, SELF-CROSSLINKING POLYIMIDE, METHOD OF MANUFACTURING SELF-CROSSLINKING POLYIMIDE, AND SELF-CROSSLINKING POLYIMIDE FILM INCLUDING THE SELF-CROSSLINKING POLYIMIDE

(75) Inventors: Byung-hee SOHN, Yongin-si (KR); Sang-mo KIM, Hwaseong-si (KR); Sang-heon HYUN, Seoul (KR); Jin-hae CHANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/718,106

(22) Filed: Mar. 5, 2010

(30) Foreign Application Priority Data
Mar. 6, 2009 (KR) 10-2009-0019428

(51) Int. Cl. C08G 73/10; C08G 69/26

(52) U.S. Cl. 528/337; 528/341

(57) ABSTRACT

Provided are a self-crosslinking polyamic acid being a condensation reaction product of melamine-based material, an acid anhydride, and a diamine compound, a self-crosslinking polyimide being a condensation and imidization reaction product of melamine-based material, an acid anhydride, and a diamine compound, a method of preparing the self-crosslinking polyimide, and a self-crosslinking polyimide film including the self-crosslinking polyimide.

### CROSS-REFERENCE TO RELATED APPLICATIONS

This application claims priority to Korean Patent Application No. 10-2009-0019428, filed on Mar. 6, 2009, and all the benefits accruing therefrom under 35 U.S.C. 119, the content of which in its entirety is herein incorporated by reference.

### BACKGROUND

1. Field

One or more embodiments relate to a self-crosslinking polyamic acid, a self-crosslinking polyimide, a method of manufacturing the self-crosslinking polyimide, and a self-crosslinking polyimide film including the self-crosslinking polyimide.

2. Description of the Related Art

Flexible display devices for transmitting, without limitation as to place or time, various types of visualized information, and which are thin and light and have low power consumption, are increasingly in demand. A flexible display device includes a flexible substrate, organic and inorganic materials for a low temperature process, flexible electronics, and encapsulation and packaging technologies. In this regard, the flexible substrate is an essential component of the flexible display device, and is determinative of the overall performance, reliability, and cost of the flexible display device.

A plastic substrate may be used as the flexible substrate because it can be easily processed, is lightweight, and can be used in continuous processes.

However, plastic substrates generally have low thermal stability, and hence the thermal properties of plastic substrates need to be improved in order for plastic substrates to be applied practically. Consequently, there is an increasing need to develop polymers such as polyimides having good thermal resistance.

Polyimide films, when heated, frequently discolor to yellow or brown from thermal deterioration as a result of severe thermal hysteresis, or as a result of the polymer structure.

Polyimides may become colored when a charge-transfer complex is formed between polymer molecules, or in a polymeric electron donor where a nitrogen atoms are present in the donor moiety, and polymeric electron acceptor where an electron acceptor where a carboxylic group is present in a polymer. To form a substrate using a polyimide, the coefficient of thermal expansion (“CTE”) must be reduced and light transmittance increased.

### SUMMARY

One or more embodiments include a self-crosslinking polyamic acid, a self-crosslinking polyimide having excellent light transmittance and thermal characteristics, a method of manufacturing the self-crosslinking polyimide, and a self-crosslinking polyimide film including the self-crosslinking polyimide.

Additional aspects will be set forth in part in the description which follows and, in part, will be apparent from the description, or may be learned by practice of the presented embodiments.

According to one or more embodiments, a self-crosslinking polyamic acid includes the condensation reaction product of a melamine-based material, an acid anhydride of Formula 1, and a diamine compound:

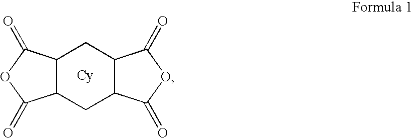

wherein

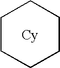

is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

According to one or more embodiments, a self-crosslinking polyimide includes a condensation and imidization product of a melamine-based material, an acid anhydride of Formula 1 below, and a diamine compound:

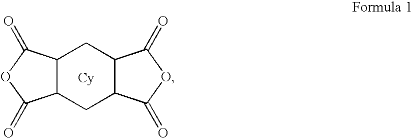

wherein

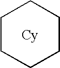

is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

According to one or more embodiments, there is provided a method of preparing a self-crosslinking polyimide, the method including: forming a self-crosslinking molecular dendrimer by mixing an acid anhydride of Formula 1 below and melamine-based material; forming a self-crosslinking polyamic acid by mixing the self-crosslinking molecular dendrimer with the acid anhydride of Formula 1 below and a diamine compound; and forming a self-crosslinking polyimide by imidizing the self-crosslinking polyamic acid:

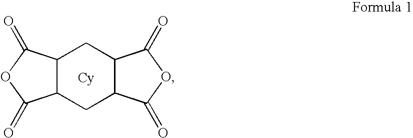

wherein

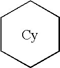

is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

According to one or more embodiments, there is provided a self-crosslinking polyimide film including the self-crosslinking polyimide.

According to the embodiments, the self-crosslinking polyimide has excellent light transmittance and thermal characteristics. A self-crosslinking polyimide film formed using the self-crosslinking polyimide is transparent and may be used in various applications such as in display devices, as a material for waveguides, a protection coating film for solar cells, in radio frequency identification (“RFID”), and electronic devices.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates an infrared (“IR”) spectrum of an exemplary polyimide prepared according to Example 1 and Comparative Example 1;

FIG. 2 illustrates a ¹³C-NMR spectrum of an exemplary polyimide prepared according to Example 1;

FIGS. 3 and 4 illustrate results of the analysis of the exemplary polyimide prepared according to Example 1 and Comparative Example 1, respectively, by using differential scanning calorimetry (“DSC”); and

FIG. 5 is a graph illustrating light transmittance of an exemplary polyimide film prepared according to Example 1 and Comparative Example 1.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof. All ranges and endpoints reciting the same feature are independently combinable.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

According to an embodiment, a melamine-based material is used as an amine compound that is mixed with an acid anhydride and as an essential component to form a self-crosslinking polyamic acid and a self-crosslinking polyimide with excellent optical characteristics and thermal characteristics.

The melamine-based material is a material containing a trivalent amine, and may be imidized with an acid anhydride to form a self-crosslinking polymer structure—dendrimer, by which a polymer network may be formed to obtain a self-crosslinking polyimide having a rigid structure.

According to an embodiment, the above-described self-crosslinking polyimide may be obtained by forming a self-crosslinking molecular dendrimer by mixing an acid anhydride of Formula 1 below and melamine-based material; forming a self-crosslinking polyamic acid by mixing the self-crosslinking molecular dendrimer with the acid anhydride of Formula 1 below and a diamine compound; and imidizing the self-crosslinking polyamic acid.

Alternatively, a self-crosslinking polyamic acid may be obtained by mixing an acid anhydride, melamine-based material, and diamine, instead of the forming of a self-crosslinking molecular dendrimer, and the forming of a self-crosslinking polyamic acid.

Hereinafter, a method of preparing a self-crosslinking polyamic acid and a self-crosslinking polyimide according to an embodiment will be described in detail.

First, melamine-based material, an acid anhydride represented by Formula 1 below, and an organic solvent are combined at a temperature of about 0° C. to about 200° C. The combination may be heated from ambient temperature or less to about 200° C., specifically from about 30° C. to about 200° C., to form a self-crosslinking molecule, and the self-crosslinking molecule is dispersed in an acid anhydride and heated to form a self-crosslinking molecular dendrimer.

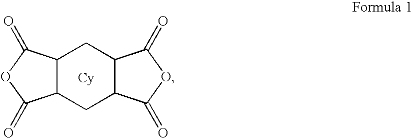

where

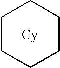

is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, an interconnected C2-C20 non-condensed polycyclic aromatic group interconnected by a substituted or unsubstituted aromatic group, and any combination thereof.

Examples of the acid anhydride include 4,4-biphthalic dianhydride (“BPDA”), 3,3″,4,4″-diphenylsulfone tetracarboxylic dianhydride (“DSDA”), 3,3″,4,4″-benzophenonetetracarboxylic dianhydride (“BTDA”), 4,4″-(hexafluoroisopropylidene)diphthalic anhydride (“6FDA”), 4,4″-oxydiphthalic anhydride (“ODPA”), pyromellitic dianhydride (“PMDA”), and (4-(2,5-dioxotetrahydrofuran-3-yl)-1,2,3,4-tetrahydronaphthalene-1,2-dicarboxylic anhydride (“DTDA”), and the like, where these acid anhydride materials may be used alone or in any combination of two or more.

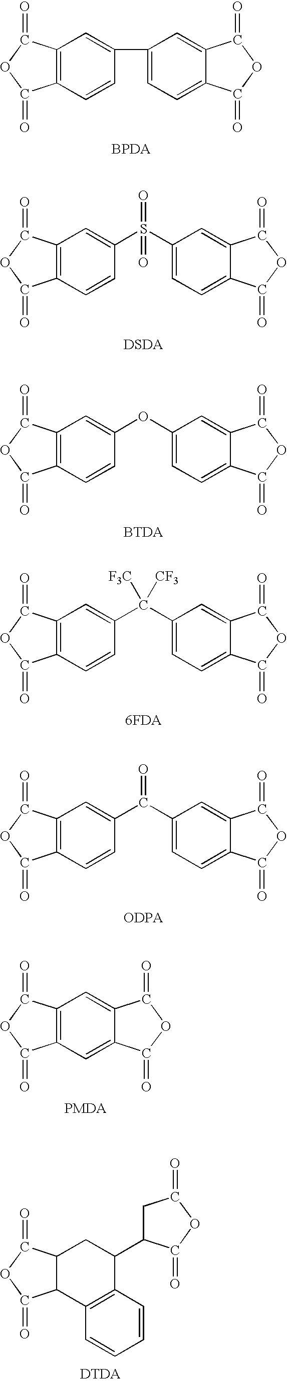

The content of the melamine-based material is about 0.0001 mol to about 0.999 mol, specifically about 0.01 mol to about 0.99, and more specifically about 0.1 mol to about 0.9 mol, based on 1 mol of the acid anhydride of Formula 1.

Examples of the organic solvent include N-methylpyrrolidone, N,N-dimethylformamide, N,N-dimethylacetamide, N-methyl caprolactam, dimethylsulfoxide, pyridine, tetrahydrofuran, cyclohexanone, 1,4-dioxane, and other such polar aprotic solvents, and the solvents may be used alone or in a combination of two or more.

The content of the organic solvent may be about 1 to about 1000 parts by weight, specifically about 10 to about 900 parts by weight, and more specifically about 50 to about 500 parts by weight, based on 100 parts by weight of the melamine-based material.

The acid anhydride is dissolved in the organic solvent at a temperature of about 0° C. to about 200° C. Examples of the organic solvent include N-methylpyrrolidone, N,N-dimethylformamide, N,N-dimethylacetamide, N-methyl caprolactam, dimethylsulfoxide, pyridine, tetrahydrofuran, cyclohexanone, 1,4-dioxane, and a polar aprotic solvent, and the solvents may be used alone or in a combination of two or more. The content of the organic solvent may be about 1 to about 1000 parts by weight, specifically about 10 to about 900 parts by weight, and more specifically about 50 to about 500 parts by weight, based on 100 parts by weight of the acid anhydride.

The reaction temperature may be about 0° C. to about 200° C.

Next, a mixture of the self-crosslinking molecular dendrimer, prepared in the above-described manner, and the acid anhydride of Formula 1, are added to a diamine compound solution, which is dissolved in a polar aprotic solvent, to mix the mixture and the amine solution and to thereby prepare a self-crosslinking polyamic acid.

The diamine compound may be a compound represented by Formula 2 below.

H₂N-A-NH₂, Formula 2

where A is one selected from the group consisting of:

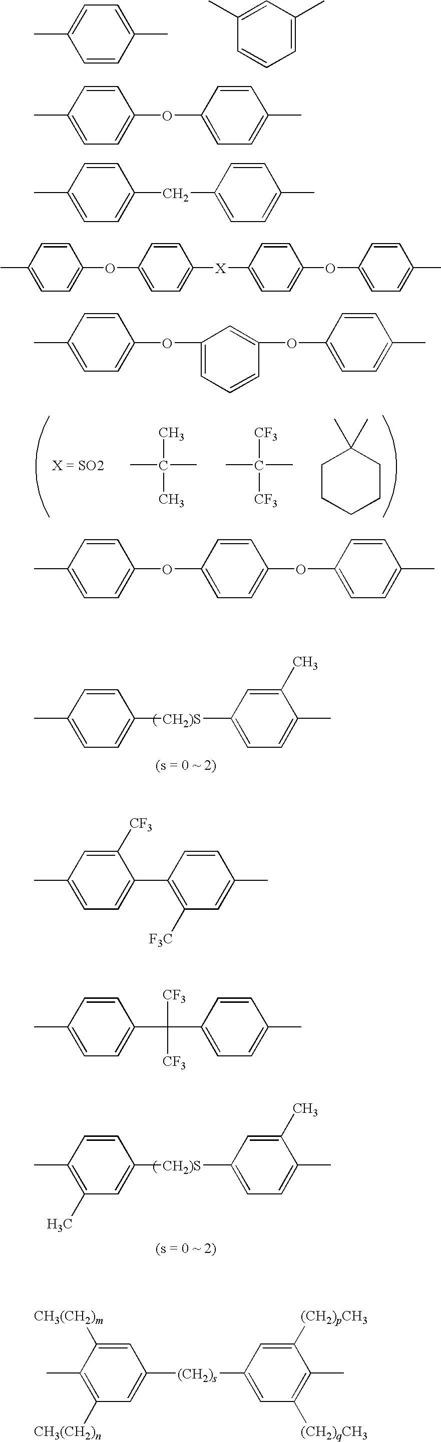

wherein m, n, p, and q are each independently an integer of 0 to 18, and s is an integer of 0 to 2,

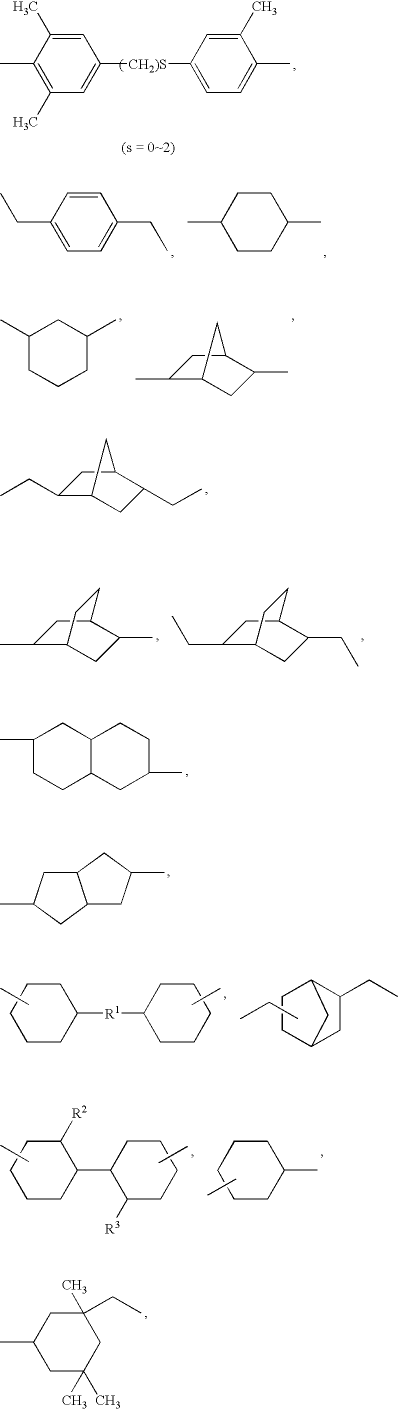

and any combination thereof.

The content of the diamine compound represented by Formula 2 may be about 0.001 to about 0.999 mol, specifically about 0.01 mol to about 0.99, and more specifically about 0.1 mol to about 0.9 mol, based on 1 mol of the acid anhydride of Formula 1. If the content of the diamine compound of Formula 2 is outside the above range, the thermal characteristics, such as thermal stability, of a polyamic acid and/or a polyimide prepared using the diamine may be reduced.

The reaction temperature for forming the polyamic acid is about 0° C. to about 100° C., specifically about 20° C. to about 100° C., and more specifically about 30° C. to about 100° C. If the reaction temperature is lower than 0° C., the formation of a polyamic acid is slow, and if the reaction temperature is higher than 100° C., the molecular weight of the final polymer obtained may be undesirably low relative to a polymer prepared at a temperature of less than 100° C.

Next, the polyamic acid is imidized to obtain a desired self-crosslinking polyimide.

The imidization may be carried out by either a chemical (e.g., by chemical dehydration) or thermal (e.g., by heating) process. In an embodiment, thermal imidization is performed.

In an embodiment, thermal imidization may be performed at a heat treatment temperature of about 80° C. to about 400° C., specifically about 150° C. to about 350° C., and more specifically in an exemplary embodiment, at a temperature of about 250° C. Generally it should be noted that the condensation is carried out at a temperature lower than the imidization.

Where the heat treatment temperature is lower than 80° C., activity of imidization may decrease and thus unreacted polyamic acid may be present. Conversely, where the heat treatment temperature is higher than 400° C., the optical characteristics of the polyimide may deteriorate as a result of, for example, discoloration.

The acid anhydride according to one embodiment may be DTDA represented by Formula 3 below.

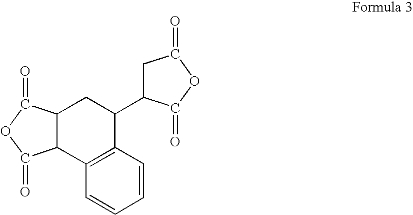

The diamine compound according to other embodiment may be bis[4-(4-aminophenoxy)phenyl]sulfone (“BAPS”) represented by Formula 4 below.

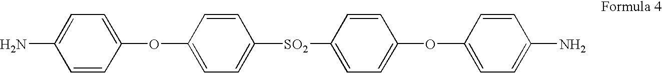

The self-crosslinking polyimide according to other embodiment may be a compound represented by Formula 5 below.

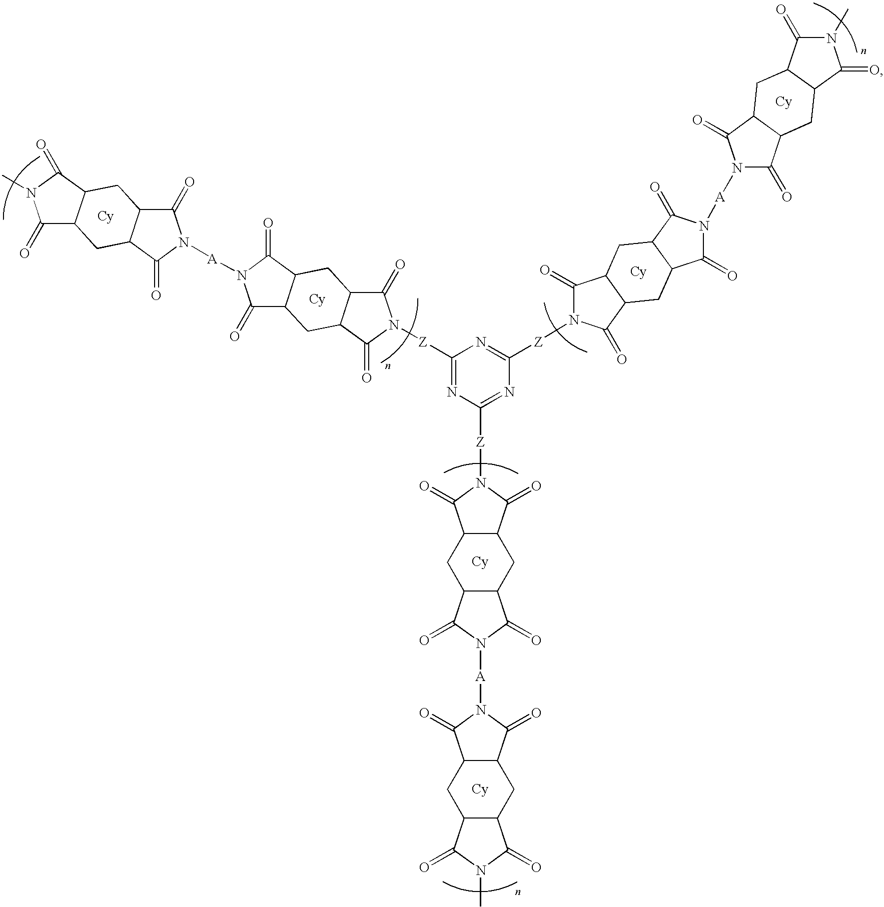

where n is a number of from about 1 to about 100,000, specifically about 5 to about 10,000, and more specifically about 10 to about 1,000, and

A is one selected from the group consisting of:

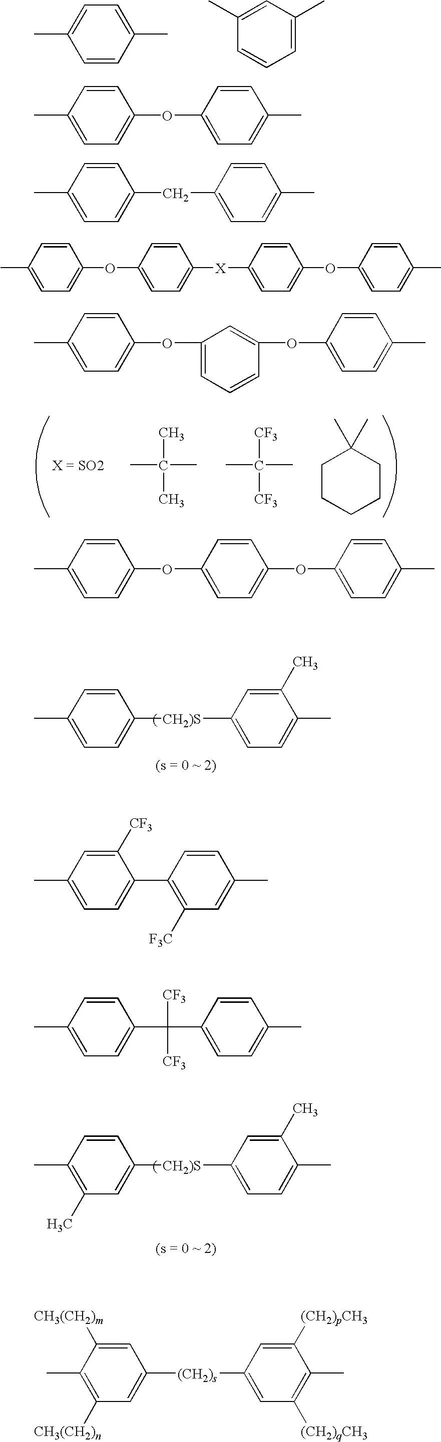

wherein m, n, p, and q are each independently an integer of 0 to 18, and s is an integer of 0 to 2,

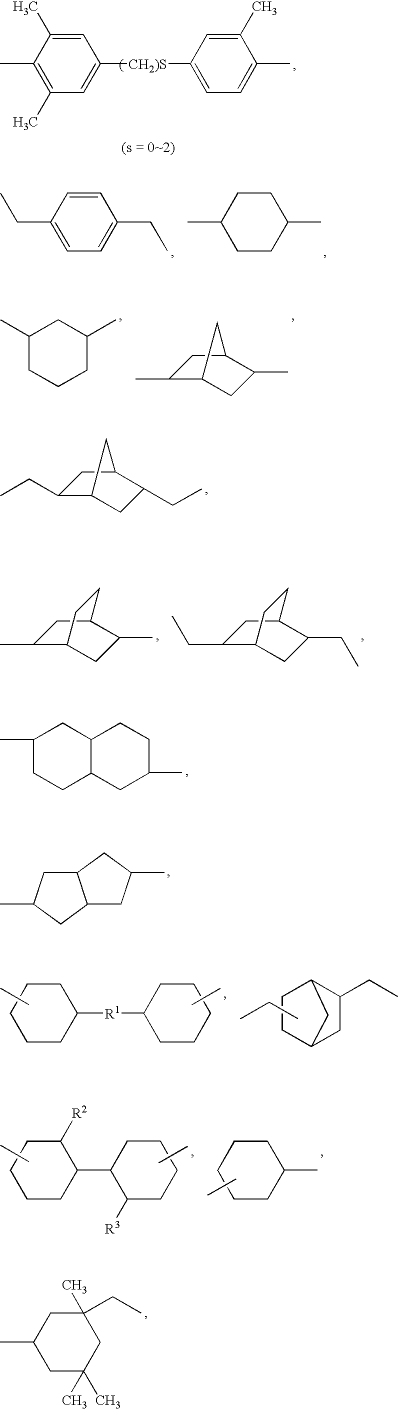

and any combination thereof, and

where

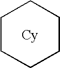

is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof, and

Z is —(CH₂)ₘ—, —NRR″CH₂)ₘ—, —(CH₂)ₘCO—, or —CO(CH₂)ₘ—, —O(CH₂)ₘ—, —CO(CH₂)ₘ—, —OC(CH₂)ₘ—, and any combination thereof, and

m is a number in the range of about 0 to about 12, and R and R′ are independently a C1-C4 alkyl group.

The compound of Formula 5 may be prepared according to the reaction shown in Reaction Formula 1 below.

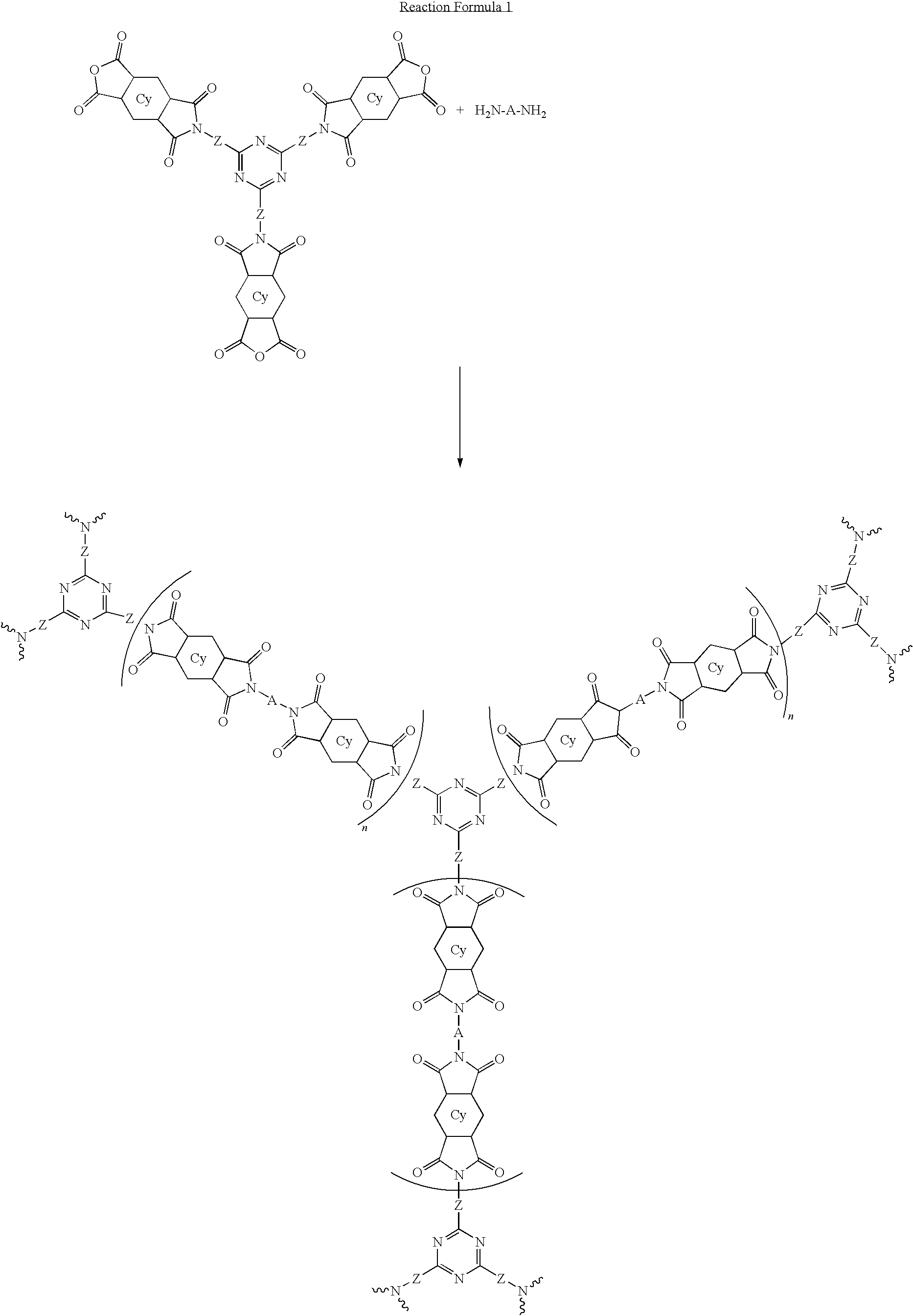

where n, A,

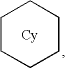

Z, R, and R′ are each as defined with respect to Formula 5.

A weight average molecular weight of the self-crosslinking polymer according to the present embodiment may be about 10,000 to about 2,000,000, specifically about 20,000 to about 1,000,000, and more specifically about 50,000 to about 500,000, and a polymerization degree thereof may be an integer of from about 1 to about 100,000, specifically about 2 to about 100,000, more specifically about 5 to about 50,000, and still more specifically about 10 to about 10,000. A glass transition temperature of the self-crosslinking polymer according to the present embodiment may be about 150° C. or greater, or because of the extent of crosslinking, may not exist at all.

According to an embodiment, the weight average molecular weight is measured using a gel permeation chromatography (“GPC”), and a dimethyl formamide (“DMF”) is used as a diluent for evaluation

A self-crosslinking polymer such as a self-crosslinking polyimide includes three types of repeating units, a crosslinking type, a linear type, and a terminal, according to a number of functional groups of monomer that do not react, and accordingly, a degree of branching of each corresponding compound may be calculated according to the following equation:

Degree of branching (DB)=2D/(2D+L),

where D and L are respectively the number (in moles) of crosslinking type units structures, and the number (in moles) of linear type unit structures.

A self-crosslinking polyimide film according to an embodiment may be manufactured using the self-crosslinking polyimide described above. In an embodiment, the thickness of the crosslinking polyimide film may be about 10 to about 200 μm, specifically about 20 to about 150 μm. In another embodiment, the self-crosslinking polyimide film may be transparent.

The self-crosslinking polyimide film according to other embodiment may have an average light transmittance of about 80% or greater, particularly, about 85% or greater, and more specifically about 90% or greater at a wavelength of about 380 to about 800 nm measured using a UV-VIS spectrometer and based on a thickness of 10 to 200 μm of the polyimide film.

The self-crosslinking polyimide film according to the present embodiment may have a yellowness index (YI) of 15 or lower, for example, 0.1 to 5, based on a thickness of 10 to 200 μm of the polyimide film.

Also, the self-crosslinking polyimide film according to the embodiment may have an average linear expansion coefficient (also referred to as the coefficient of thermal expansion), of 100 ppm/° C. or less, for example, 3 to 80 ppm/° C. measured at a temperature of 50 to 200° C., based on a thickness of 10 to 200 μm of the polyimide film.

When measuring light transmittance, a 100% cut off wavelength may be 400 nm or less. The term “100% cut off wavelength” refers to a light transmittance of 0%.

The self-crosslinking polyimide film according to the embodiment may have a permittivity of 3.0 or less at 1 GHz.

The self-crosslinking polyimide film according to the present embodiment has excellent thermal stability, electrical characteristics, and mechanical properties, and is transparent, and thus may be used as an optical film, a compensation film for liquid crystal display devices or an organic light emitting diodes, an alignment layer for liquid crystal display devices, a material for waveguides, a protection coating film for solar cells, or a radio frequency identification (RFID) substrate, and also as a protection layer of other devices.

The polyimide film according to the embodiment may be used in optical films and liquid crystal display devices.

Hereinafter, substitution groups used in the formulas shown above will be described.

Examples of the C4-C20 carbon cyclic group include a monocyclic aromatic group that is used alone or in a combination of two or more, and the carbon cyclic group may have a substituent group such as a halogen atom, a halo alkylene group, a nitro group, a cyano group, an alkoxy group, a C1-C4 alkyl amino group, or any combination thereof.

A C6-C20 monocyclic aromatic group is used alone or in a combination, and refers to a C6-C20 carbocyclic aromatic system including one aromatic ring. A hydrogen atom of at least one monocyclic aromatic group may also be substituted like the above-described carbon cyclic group.

A C2-C20 condensed polycyclic aromatic group refers to a structure in which carbocyclic aromatic rings are condensed with one another, and a hydrogen atom of at least one of the condensed cyclic aromatic groups may also be substituted with a substituent group such as the carbon cyclic group.

An interconnected C2-C20 non-condensed polycyclic aromatic group that is interconnected via an aromatic group refers to an aromatic group system in which several cycles are connected to one another directly by an aromatic group or a linker. A hydrogen atom of at least one of the interconnected C2-C20 non-condensed polycyclic aromatic group by an aromatic group may also be substituted with a substitution group such as a carbon cyclic group.

Hereinafter, the embodiments will be described with reference to Examples, but are not limited thereto.

### Example 1

### Preparation of Self-Crosslinking Polyimide Film

0.1 g of melamine was mixed with 20 ml of N-methylpyrrolidone, and the mixture was slowly added to a solution prepared by dissolving 0.714 g (1 equivalent, 0.002379 mol) of DTDA of Formula 3 in 30 ml of N-methylpyrrolidone, to form a self-crosslinking molecular dendrimer.

1 equivalent of the dendrimer was added to 1.5433 g (1.5 equivalent, 0.003569 mol) of BAPS of Formula 4, and was heated at 50° C., for a time sufficient to form a self-crosslinking polyamic acid.

The self-crosslinking polyamic acid was cast without further dilution from NMP on a glass substrate and heated at 50° C. for 1 hour to provide a stable film.

The resultant structure was treated in a vacuum of 10⁻¹ torr and at 80° C. to remove the solvent, and the temperature was increased at a rate of 6° C./min to 200° C. The temperature was maintained at 200° C. for 10 minutes before being lowered again to 10° C.

Then, a polyimide film having a thickness of 80 μm was exfoliated from the glass substrate using warm water.

### Comparative Example 1

### Preparation of Polyimide Film

To a solution in which 1.0288 g (1.5 equivalent, 0.002379 mol) of BAPS of Formula 4 was dissolved to 20 ml of N-methylpyrrolidone, a solution of 0.714 g (1 equivalent, 0.002379 mol) of DTDA of Formula 3 dissolved in 20 ml of N-methylpyrrolidone was slowly added, and the resultant heated to a temperature of 50° C. to obtain a polyamic acid.

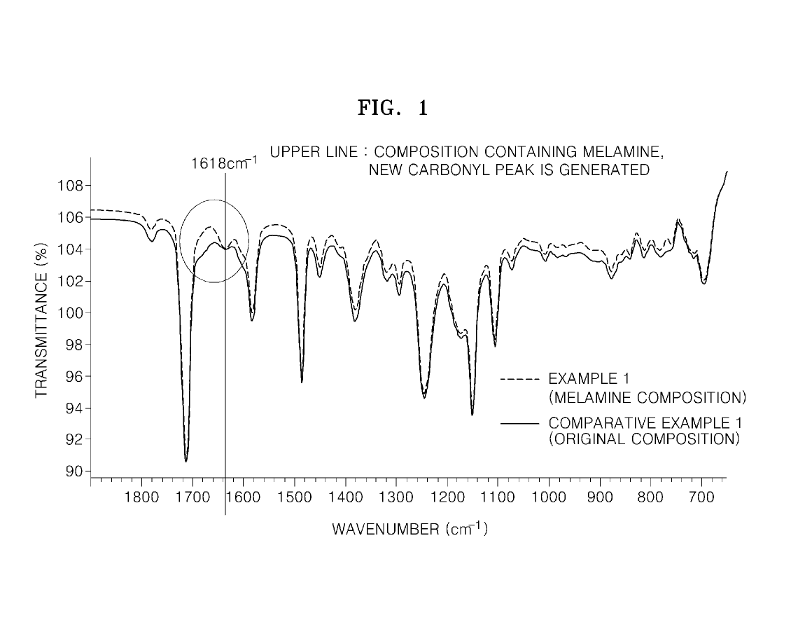

Infrared (IR) analysis of the self-crosslinking polyimide prepared according to Example 1 and the polyimide prepared according to Comparative Example 1 was conducted, and a spectrum of the self-crosslinking polyimide (dashed line) for the Example 1 and the Comparative Example 1 (solid line) are shown in FIG. 1.

Referring to FIG. 1, the anhydride band of 1790 cm⁻¹ and a new carboxyl C═O band at 1618 cm⁻¹ are shown (see FIG. 1, dashed line). The new carboxyl C═O band is a C═O band of an imide that was formed by mixing melamine and an anhydride (compare with the IR spectrum of the comparative Example 1, which does not include melamine and does not exhibit the new carbonyl band).

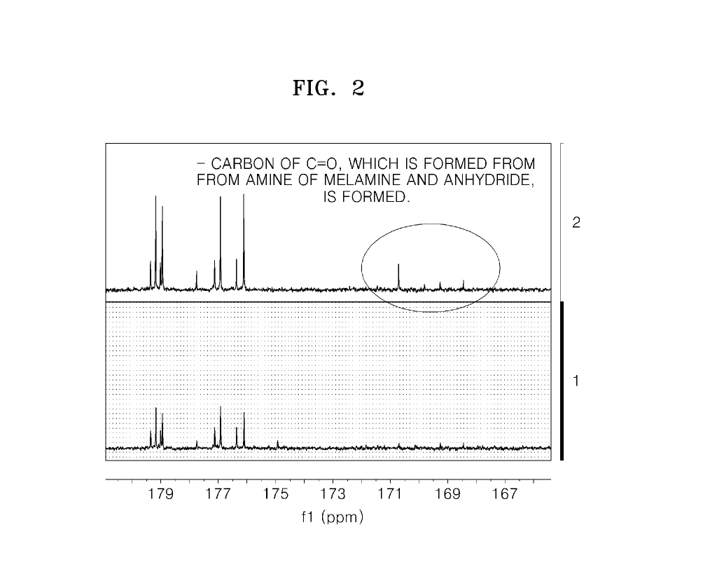

In addition, ¹³C-NMR analysis was conducted with respect to the self-crosslinking polyimide prepared according to Example 1 and Comparative Example 1. The spectra are shown in FIG. 2.

As can be seen from FIG. 2, the upper spectrum (2) shows resonances which correspond to imide C═O carbons (encircled portion of spectrum (2)) for Example 1, which were formed by the reaction of the melamine and an anhydride, where the comparison spectrum (1) for Comparative Example 1 which is a polymer without melamine included, does not show these same resonances.

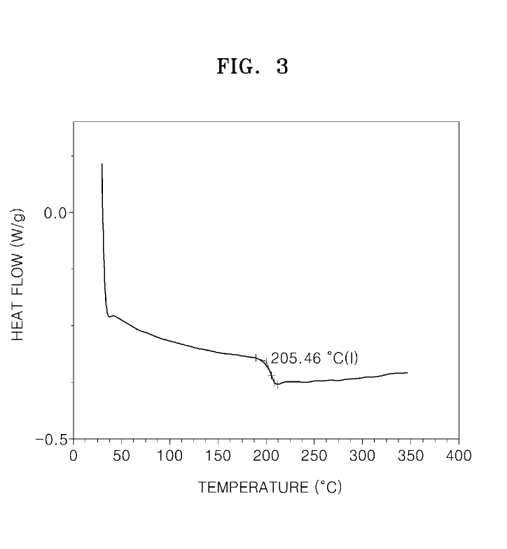

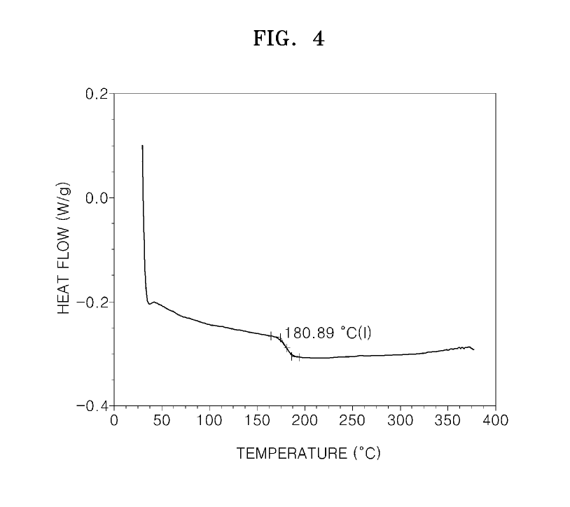

Thermogravimetric analysis (TGA) was conducted with respect to the polyimide obtained according to Example 1 and Comparative Example 1, and results for maximum decomposition point are shown in Table 1 below. In addition, differential scanning calorimetry (“DSC”) analysis was conducted with respect to polyimide prepared according to Example 1 and Comparative Example 1, and results are shown in FIGS. 3 and 4, respectively, and Table 1, below.

TABLE 1

| | Glass transition | Maximum decomposition point |
|---|---|---|
| | temperature (Tg)(° C.) | temperature (Td)(° C.) |
| Example 1 | 205.46 | 481.1 |
| Comparative | 180.89 | 461.6 |
| Example 1 | | |

As can be seen from Table 1, the self-crosslinking polymer of Example 1 has a lower glass transition temperature and a higher maximum decomposition temperature (i.e., in a TGA trace, the inflection point at which the rate of decomposition slows and begins to level off), when compared to those of Comparative Example 1. Thus, it can be seen that the thermal characteristics of the self-crosslinking polyimide of Example 1 are better than the polyimide of Comparative Example 1.

As seen in FIG. 3, the glass transition temperature for the melamine containing polymer of Example 1 is greater than that of Comparative Example 1 seen in FIG. 4.

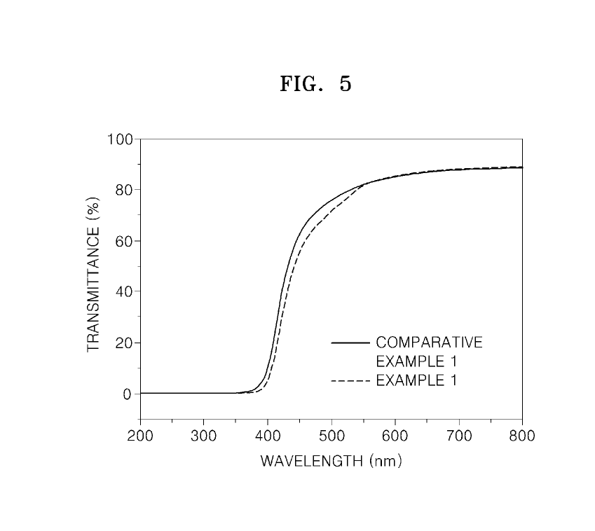

Also, the transmittance of the polyimide films formed of the polyimide obtained according to Example 1 and Comparative Example 1 was measured and is shown in FIG. 5

Referring to FIG. 5 the polyimide film according to Example 1 had excellent transmittance of 80% or greater, like that of the polyimide film according to Comparative Example 1.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A self-crosslinking polyamic acid comprising a condensation reaction product of melamine-based material, an acid anhydride of Formula 1, and a diamine compound: 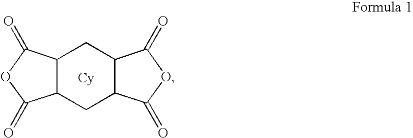
wherein 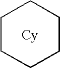
is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

2. The self-crosslinking polyamic acid of claim 1, wherein the diamine compound is represented by Formula 2 below,
H₂N-A-NH₂, Formula 2
where A is one selected from the group consisting of: 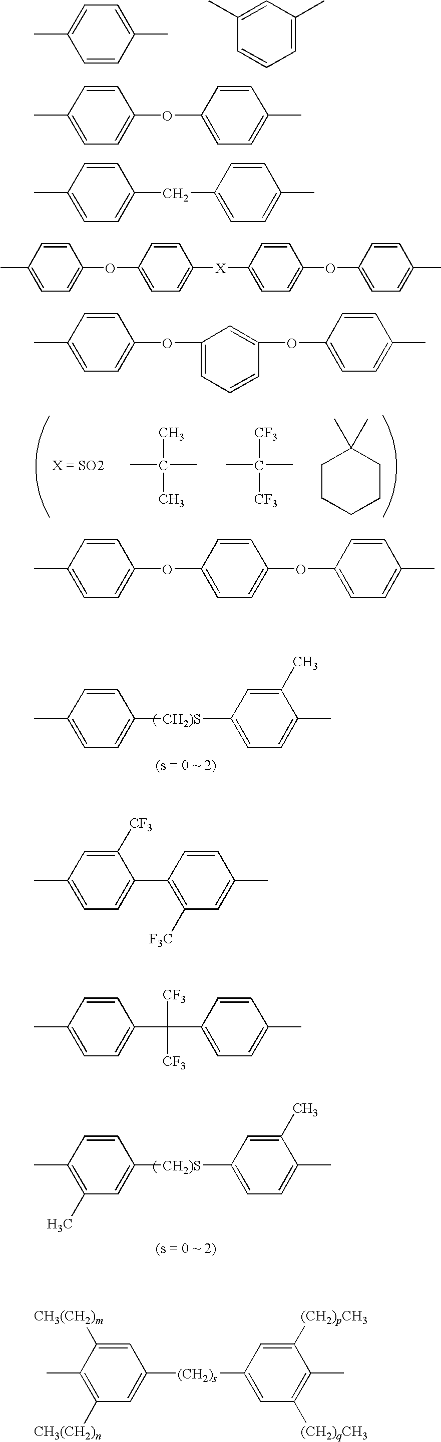
wherein m, n, p, and q are each independently an integer of 0 to 18, and s is an integer of 0 to 2, 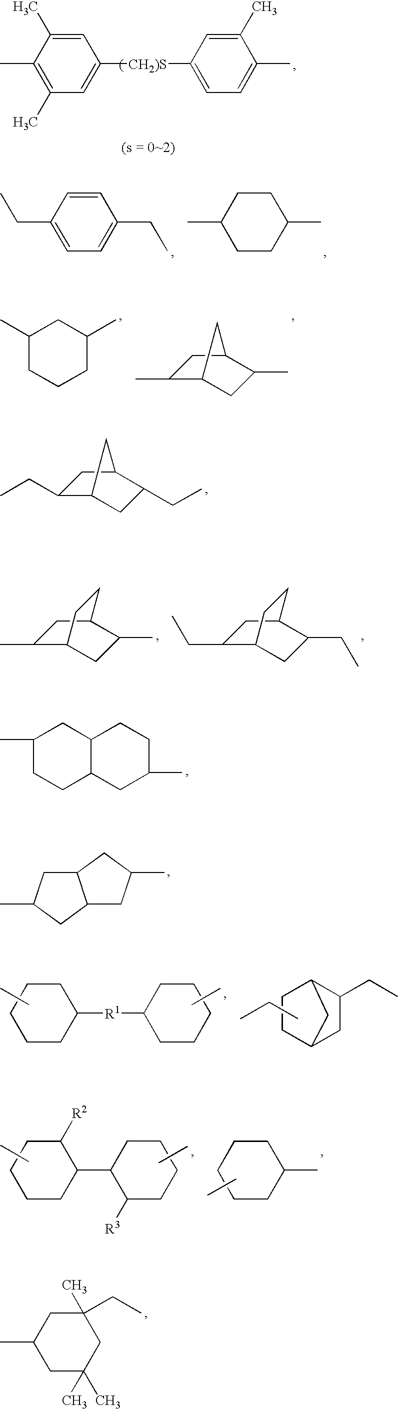
and any combination thereof.

3. The self-crosslinking polyamic acid of claim 1, wherein the acid anhydride is a compound represented by the formula:

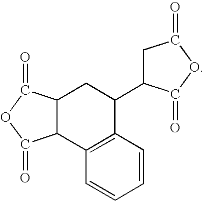

4. The self-crosslinking polyamic acid of claim 1, wherein the diamine compound is a compound represented by the formula:

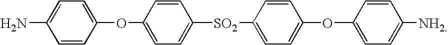

5. A self-crosslinking polyimide comprising a condensation and imidization product of melamine-based material, an acid anhydride of Formula 1 below, and a diamine compound: 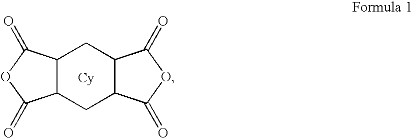
wherein 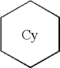
is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

6. The self-crosslinking polyimide of claim 5, wherein the diamine compound is represented by Formula 2 below:
H₂N-A-NH₂, Formula 2
where A is one selected from the group consisting of: 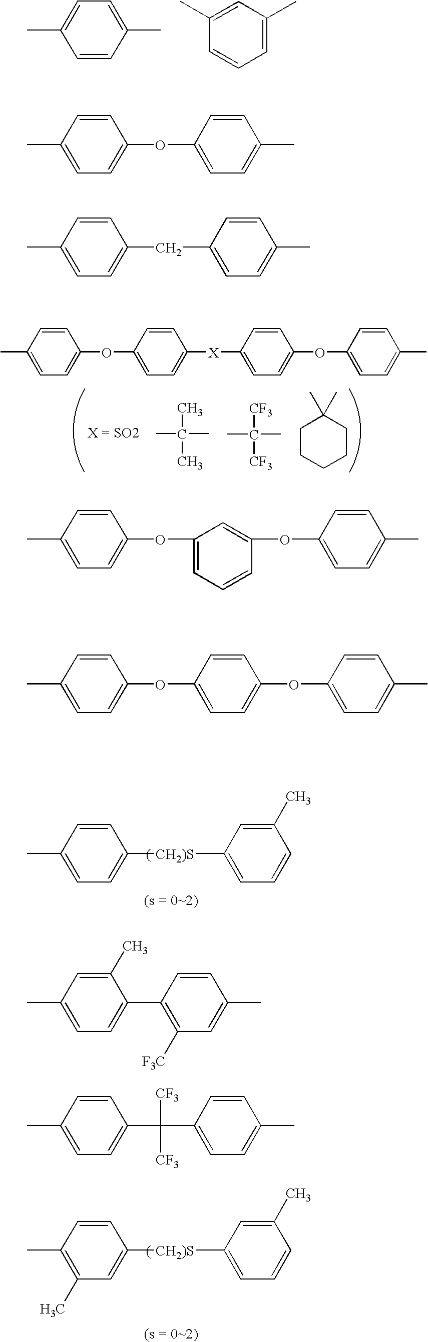 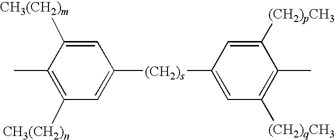
wherein m, n, p, and q are each independently an integer of 0 to 18, and s is an integer of 0 to 2, 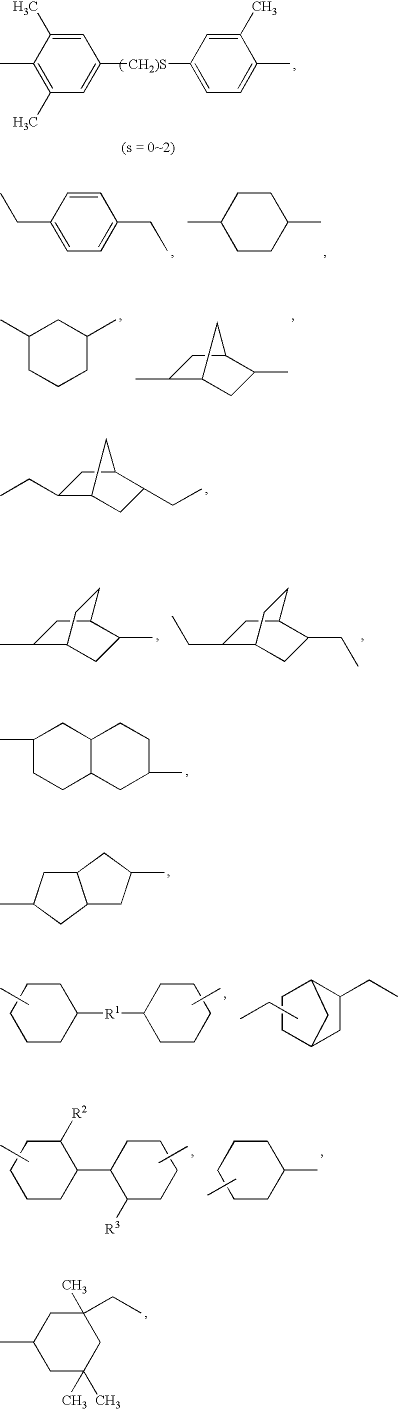
and any combination thereof.

7. The self-crosslinking polyimide of claim 5, wherein the acid anhydride is a compound represented by the formula:

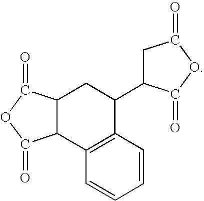

8. The self-crosslinking polyimide of claim 5, wherein the diamine compound is a compound represented by the formula as follows:

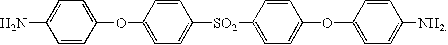

9. The self-crosslinking polyimide of claim 5, wherein the self-crosslinking polyimide is a compound represented by Formula 3 below: 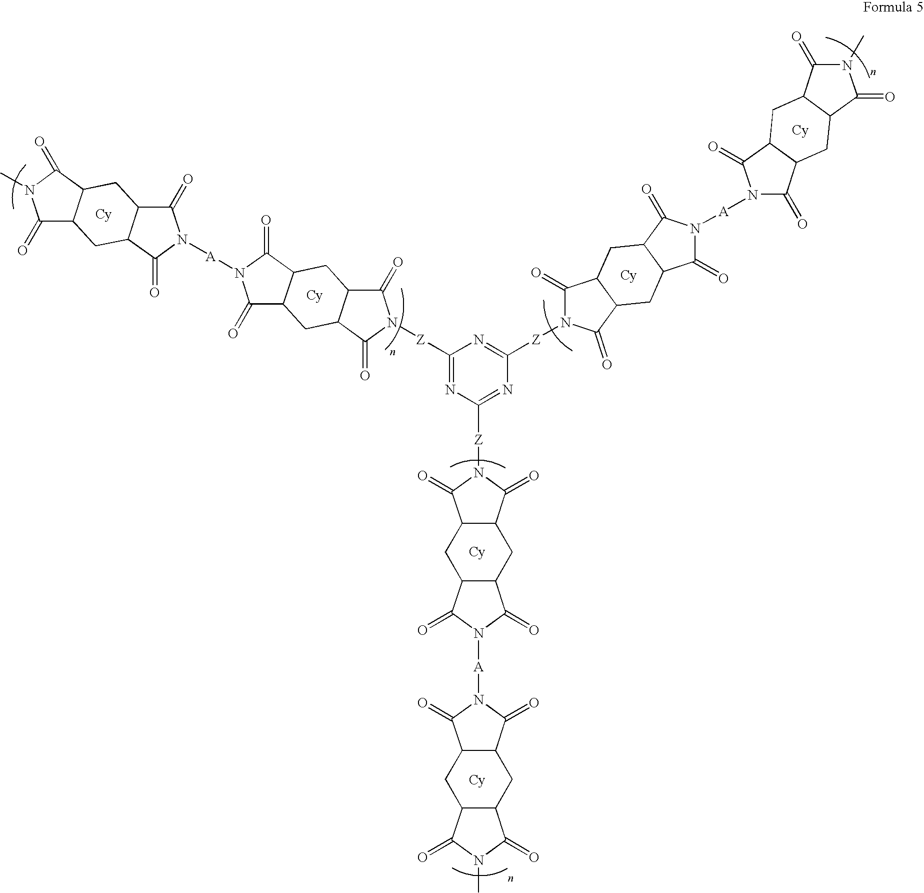
wherein n is a number of from about 1 to about 100,000, and
A is one selected from the group consisting of: 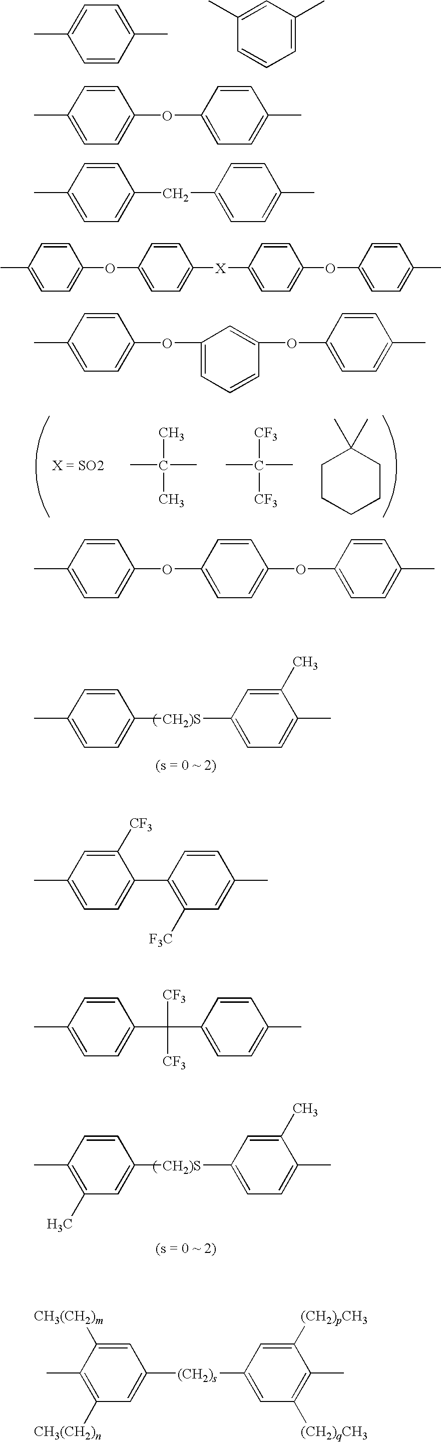
wherein m, n, p, and q are each independently an integer of 0 to 18, and s is an integer of 0 to 2, 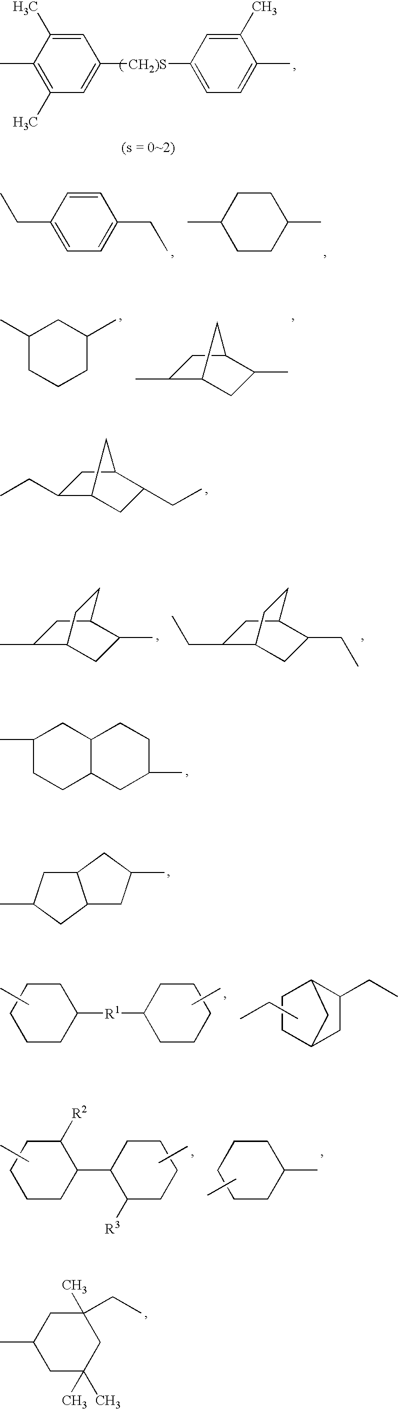
and any combination thereof, and
wherein 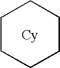
is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and
Z is selected from the group consisting of —(CH₂)ₘ—, —NRR″(CH₂)ₘ—, —(CH₂)ₘCO—, and —CO(CH₂)ₘ—, —O(CH₂)ₘ—, —CO(CH₂)ₘ—, —OC(CH₂)ₘ—, and any combination thereof, and
m is a number of 0 to 12, and R and R′ are independently a C1-C4 alkyl group.

10. The self-crosslinking polyimide of claim 5, wherein a weight average molecular weight of the self-crosslinking polyimide is about 10,000 to about 200,000.

11. A method of preparing a self-crosslinking polyimide, the method comprising:
forming a self-crosslinking molecular dendrimer by mixing an acid anhydride of Formula 1 below and melamine-based material;
forming a self-crosslinking polyamic acid by mixing the self-crosslinking molecular dendrimer, with the acid anhydride of Formula 1 below and a diamine compound; and
forming a self-crosslinking polyimide by imidizing the self-crosslinking polyamic acid: 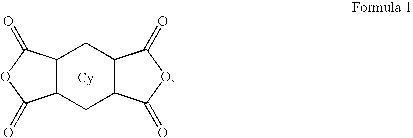
wherein 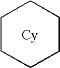
is a trivalent or a quadrivalent organic group selected from the group consisting of a substituted or unsubstituted C4-C20 carbon cyclic group, a substituted or unsubstituted C6-C20 monocyclic aromatic group, a substituted or unsubstituted C2-C20 condensed polycyclic aromatic group, a substituted or unsubstituted interconnected C2-C20 non-condensed polycyclic aromatic group interconnected by an aromatic group, and any combination thereof.

12. The method of claim 11, wherein, in the forming of a self-crosslinking molecular dendrimer, the content of the melamine-based material is about 0.0001 mol to about 0.999 mol based on 1 mol of the acid anhydride of Formula 1.

13. The method of claim 11, wherein, in the forming a self-crosslinking polyamic acid, the content of the diamine compound is about 0.001 mol to about 0.999 mol based on 1 mol of the acid anhydride of Formula 1.

14. The method of claim 11, wherein the self-crosslinking polyamic acid is prepared at a reaction temperature of about 0° C. to about 100° C.

15. The method of claim 11, wherein the self-crosslinking polyimide is prepared at a reaction temperature of about 80° C. to about 400° C.

16. A self-crosslinking polyimide film comprising a self-crosslinking polyimide according to claim 5.
